(19) United States
(12) Patent Application Publication
(10) Pub. No.: US 2009/0194020 A1
(43) Pub. Date: Aug. 6, 2009

(54) Vehicle tire coating apparatus

(76) Inventor: G. Thomas Ennis, Venice, CA (US)

Correspondence Address: MATTINGLY & MALUR, P.C., 1800 DIAGONAL ROAD, SUITE 370, ALEXANDRIA, VA, 22314, US

(21) Appl. No.: 12/068,250

(22) Filed: Feb. 5, 2008

(51) Int. Cl. B05C 1/06

(52) U.S. Cl. 118/256

(57) ABSTRACT

An apparatus for applying a coating fluid to a vehicle tire includes an applicator mounted to a base by a pair of swing arms pivotally attached thereto. Means are provided for pivoting the swing arms to move the applicator inwardly and outwardly relative to the base and for moving an applicator pad mounted on the applicator inwardly and outwardly relative to the applicator. Means are provided for supplying fluid to the applicator so that fluid is supplied to the vehicle tires when the applicator pad engages the tires. The applicator has a removable top cover plate and the applicator pads have a removable outer cover comprised of a deep pile, fur-like material.

### BACKGROUND OF THE INVENTION

1. Field of the Invention

The present invention relates to a vehicle tire coating apparatus and, more particularly, to an apparatus for applying a fluid to a vehicle tire.

2. Description of the Related Art

Many types of automatic vehicle washing apparatuses are known in the vehicle washing industry. These automatic washing devices perform various washing steps as a vehicle is conveyed or otherwise moved along a predetermined path through a washing facility. Many of these washing facilities include an apparatus for applying a fluid or coating such as a gloss or dressing fluid to the tires. The dressing fluid can either be applied manually directly to the tires, automatically directly to the tires or applied to the tires through an applicator pad.

The prior art apparatuses which employ applicator pads for applying a coating or dressing fluid to a tire have certain disadvantages. Thus, the applicator pads wear out and must often be replaced. Such replacement can be time consuming and relatively expensive. Also, a suitable material must be found which holds an amount of fluid sufficient to apply inadequate coating onto the tire vehicle. Moreover, the prior art devices often do not provide a way to adequately tuck away or store the pad when the pad is not in use.

Accordingly, there is still a need for an apparatus for coating the tires of a vehicle which efficiently applies a fluid to the vehicle tires and which contains an applicator pad which has an easily replaceable outer cover.

### SUMMARY OF THE INVENTION

It is an object of the present invention to provide an apparatus for applying a fluid such as a gloss to a vehicle tire which has a first set of arms for moving an applicator toward a tire and a second set of arms for moving an applicator pad mounted on the applicator into contact with a vehicle tire.

It is another object of the invention to provide an apparatus for applying a fluid to a vehicle tire which includes an applicator pad having an outer coating of a deep pile, fur-like material which may be easily replaced.

A further object of the invention is to provide an apparatus for applying a fluid to a vehicle tire which protects the coating unit from external elements.

It is still another object of the present invention to provide an apparatus for applying a fluid to vehicle tire which includes an applicator having a removable top cover to provide easy access to the inside of the applicator.

It is another object of the present invention to provide an apparatus for applying a fluid to a vehicle tire which has a cover of hard plastic material on an outer edge of an applicator to protect and guide tires when an applicator pad is not extended into contact with the tires.

The present invention achieves the above and other objects by providing an apparatus for applying a fluid such as a gloss or tire dressing to a vehicle tire which includes a base having an applicator attached thereto by a pair of pivotally attached swing arms extending between the base and the applicator. Means such as a power cylinder are provided for pivoting the swing arms to move the applicator outwardly and inwardly relative to the base. An applicator pad is mounted on the applicator by a pair of extension of arms pivotally attached between the applicator frame and applicator pad with means such as a power cylinder being provided for extending and retracting the applicator relative to the applicator frame whereby the applicator pad engages a vehicle tire when extended. Means such as a manifold and nozzles are provided for supplying fluid to the applicator pad.

The apparatus further includes a removable top cover plate attached to the applicator frame which has a tire guide constructed of a hard plastic material attached thereto. A protective shield preferably made from a flexible clear plastic material extends downwardly from an inner edge of the cover plate to protect the applicator pad when it is not in use.

The applicator pad is constructed of an inner body of foam rubber, a felt inner cover over the body and a removable outer cover constructed of a deep pile, fur-like material over the inner cover. The applicator pad also may be constructed of a pair of stacked applicator pads rather than a single applicator pad.

These and other features and advantages of the present invention will become more apparent with the following detailed description and drawings.

### BRIEF DESCRIPTION OF THE DRAWINGS

FIG. 1 is a schematic top plan view of an apparatus for applying a fluid to a vehicle tire illustrating a vehicle moving along a predetermined path toward left and right applicators, each with an applicator pad being extended;

FIG. 2 is a schematic top plan view showing the left and right applicator retracted to the sides of the path;

FIG. 3 is an enlarged perspective view showing an air cylinder attached to the back of an applicator pad;

FIG. 4 is perspective showing the left applicator in an extended position;

FIG. 5 is a schematic side view of an applicator showing the applicator pad in an extended position;

FIG. 6 is a schematic side view of an applicator showing the applicator pad in a retracted position;

FIG. 7A is a schematic side view of a second embodiment of the invention in which two applicator pads are employed in a stacked relationship and as shown are retracted whereby a tire guide contacts a tire;

FIG. 7B is a schematic side view of the embodiment of FIG. 7A showing the two applicator pads in an extended position engaging a vehicle tire;

FIG. 8A is a perspective view showing an applicator in a retracted position with the top plate held in place by a removable pin and a button head screw;

FIG. 8B is an enlarged view of a removable pin and attached cord shown in the dotted line circle of FIG. 8A;

FIG. 8C is a perspective showing an applicator with the top cover plate moved off to the left side and illustrates a manner in which the cover plate is attached to the applicator frame by the removable pin;

FIG. 9 is an isometric view of an applicator with the top cover plate totally removed and the applicator pad extended;

FIG. 10A is a front view showing an illuminated sign indicating when tire gloss is being applied; and

FIG. 10B is a side view of another embodiment of an illuminated sign indicating when tire gloss is being applied and having a concave mirror in the center reflecting an image of the tire gloss being applied.

### DETAIL DESCRIPTION OF THE PREFERRED EMBODIMENTS

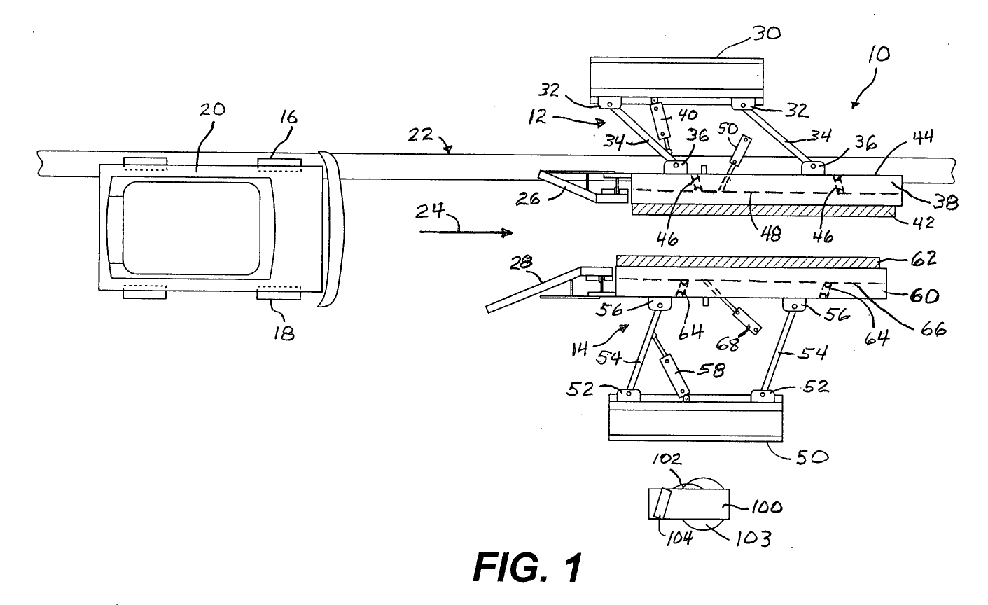

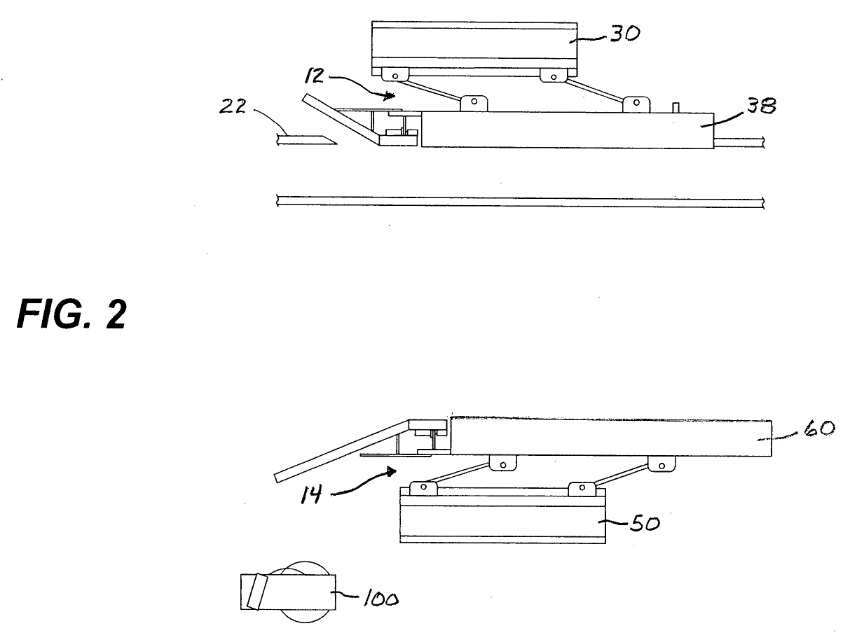

Illustrated in FIGS. 1 and 2 of the drawings is a vehicle tire coating apparatus 10 according to the present invention which includes a left applicator assembly 12 and a right applicator assembly 14 which apply a fluid such as a tire gloss or other coating to the side walls of left tires 16 and right tires 18 of a vehicle 20 moving along a predetermined path or track 22 of a vehicle washing facility in a direction from left to right as indicated by the arrow 24.

Various other components of a vehicle washing facility also may be located along the path 22 to wash a car. The vehicle tire coating apparatus 10 preferably is located at the end of the track 22 so that a coating or fluid such as tire gloss is applied to the tires after the vehicle has been washed. The washing facility further includes a control system and conveying means for moving the vehicle along the path or track 22. When a customer indicates that tire gloss is desired to be applied to the wheels, a switch of the control system is turned on whereby when the vehicle approaches the tire coating apparatus, one of the tires rolls over a floor mounted switch and activates the tire coating apparatus so that it moves from a retracted position as shown in FIG. 2 to an extended position as show in FIG. 1.

The left applicator assembly is provided with a left deflector 26 and the right applicator assembly is provided with a right deflector 28. Both the left and right deflectors are provided with an outer rubbing bar of ultra high molecular weight plastic material. As the vehicle is conveyed along the path 22 by suitable conveying means, which are known in the art, on the left hand track, the right hand side of the vehicle where the tires are not in a track first contacts the longer right reflector 28 which then adjusts outwardly to accommodate different widths of vehicles. The tires on the left hand side of the vehicle stay in the track 22 and as the vehicle contacts the left deflector 26, the left applicator assembly 12 moves outwardly while maintaining a parallel relationship with the track 22. In this fashion, the applicators of the applicator assemblies 12 and 14 remain in contact with the tires of a vehicle as it passes therethrough.

Each applicator assembly 12 and 14 is of the same construction except that the right reflector 28 of the right applicator 14 is longer than the left reflector 26 of the left applicator 12. Since each applicator is of the same construction, the left applicator assembly will be described in detail and the right applicator assembly operates in a similar manner.

The left applicator assembly 12 includes a base 30 mounted on a suitable surface and having pivot mountings 32 which are pivotally connected to the outer ends of a pair of parallel swing arms 34. The inner ends of swing arms 34 are pivotally connected to pivot mountings 36 on an outer wall of left applicator 38.

Suitable power means such as an air cylinder 40 pivotally connected at one end to the base 30 and at its opposite inner end to the forward swing arm 34 are provided to pivot the swing arms to cause the applicator 38 to move outwardly and inwardly relative to the base 30. Other power means such as a hydraulic cylinder also may be used.

The left applicator 38 is provided with an applicator pad 42 which is pivotally connected to an applicator frame 44 by a pair of pivotally connected extension arms 46. The extension arms 46 are pivotally attached at their inner ends to a back frame member 48 of the applicator pad 42. A power means such an air cylinder 50 is attached to the back frame member 48 to extend and retract the applicator pad 42 with respect to the applicator 38. Other suitable power means such as a hydraulic cylinder also may be used. The applicator pad 42 is shown extended in FIG. 1.

The right applicator assembly 14 is constructed and operates similar to the left applicator assembly 12 and is comprised of a base 50, pivot mountings 52, swing arms 54, pivot mountings 56, a cylinder 58 for the swing arms and an applicator 60 having an applicator pad 62 mounted therein. The applicator pad 62 is movable with respect to the applicator 60 by means of a suitable cylinder such as an air cylinder 68 connected to a back frame member 66 of the applicator pad. The applicator pad 62 is pivotally connected to the applicator 60 by means of a pair of pivotally connected extension arms 64.

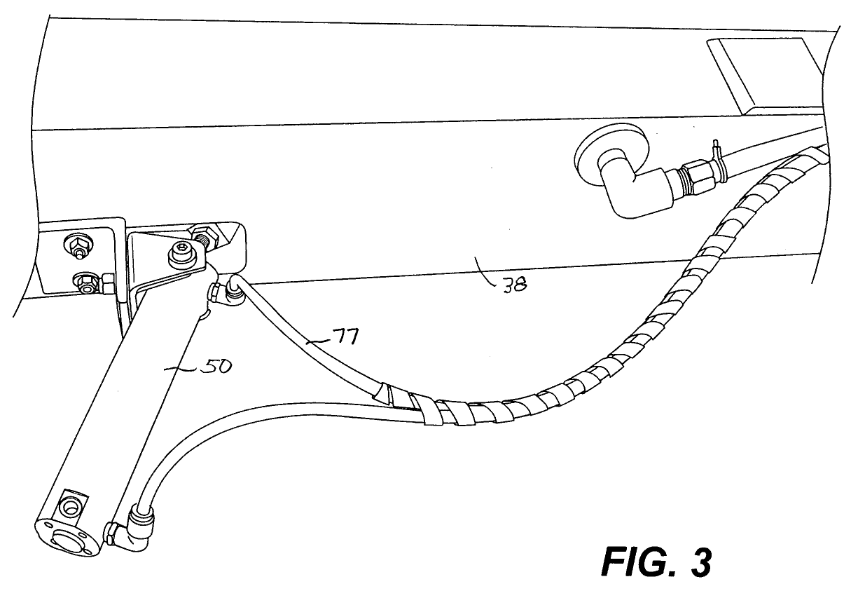

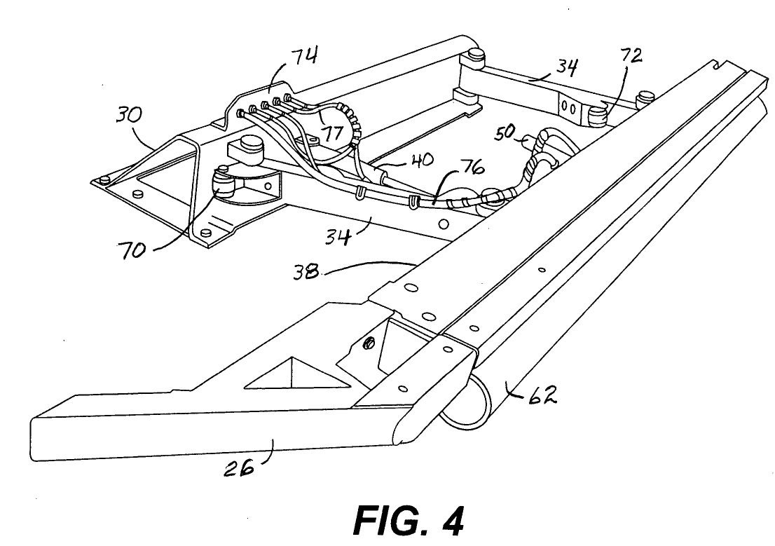

Further details of the vehicle tire coating apparatus of the present invention are shown in FIGS. 3-10. Referring to FIG. 4, the forward or left swing arm 34 of the left applicator 38 is provided with a roller bumper 70 at its outer end where the swing arm is pivotally connected to the base 30 whereby the roller bumper engages an inner wall of the base 30 when the applicator 38 is in an extended position. The right arm 38 of the left applicator 38 is provided with a roller bumper 72 which engages the back or outer wall 66 of the left applicator 38 when the left applicator is in the retracted position. A tubing plug-in manifold 74 is provided for holding the tubes 77 which distribute air to the cylinders 40 and 50 for the swing arm 34 and the applicator pad 42. The cylinder 40 preferably is a 10 inch air cylinder while the cylinder 50 preferably is a 5 inch air cylinder. Other suitable power means may be used such as hydraulic cylinders in place of the air cylinders. A fluid supply line 76 is also connected to the manifold 74 for supplying a coating fluid to the applicator pad 62. The supply line is connected to a source of fluid. The fluid may be a tire gloss chemical or other suitable fluid.

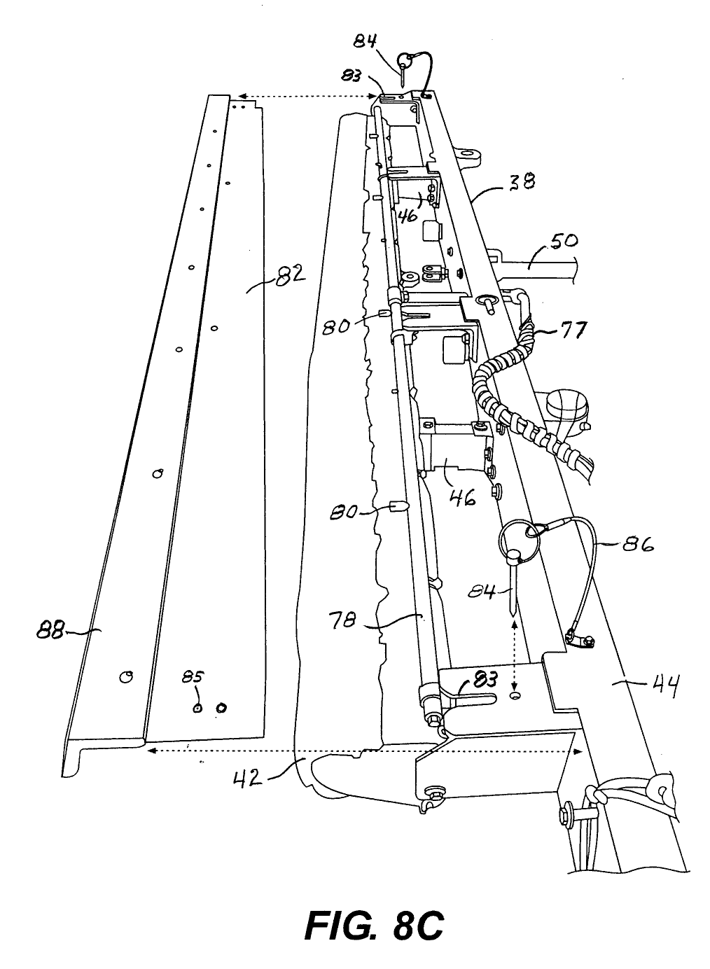

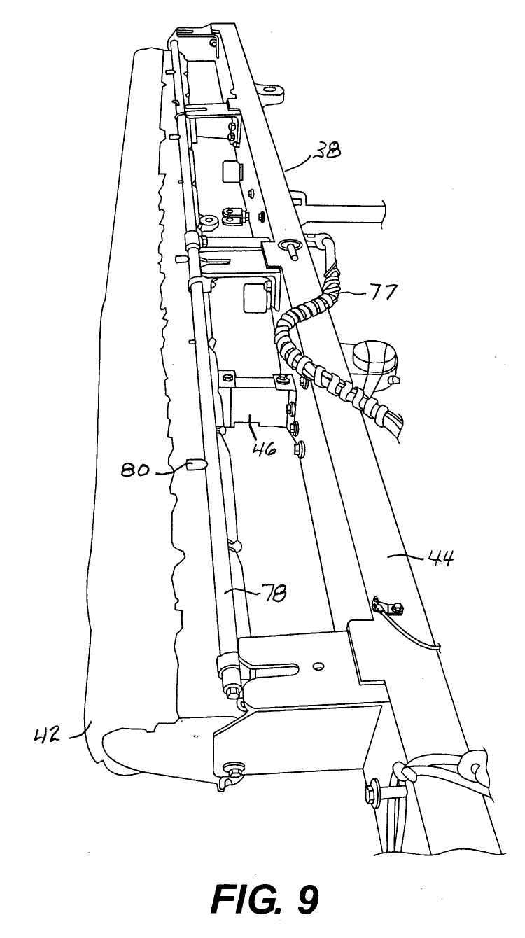

As shown in FIG. 8C and FIG. 9, the fluid from supply line 77 is supplied to a manifold 78 which extends along the length of applicator pad 42 and is generally parallel to the applicator pad 42. The manifold 72 in turn distributes the fluid to a plurality of nozzles 80 attached to the manifold which spray the fluid onto the applicator pad 42.

As best shown in FIGS. 8A and 8C, a removable top cover plate 82 is mounted to the frame 44 of the left applicator 38. The top cover plate 82 is removably secured to the top of the frame 44 by removable pins 84 which are attached to the frame 44 through a cord 86 and button head screws 85 which fit in slots 83 in the applicator frame. An enlarged view of the pin 82 and the cord 86 is shown in FIG. 8B. Thus, to remove the top cover plate 82 it is merely necessary to remove the pins 82 which fit through cooperating holes in the top cover plate and the frame and slide the button head screws out from the slots.

A tire guide 88 is attached to the inner portion of the top cover plate 82. The tire guide preferably is constructed of a hard plastic material such as an ultra high molecular weight plastic. When the applicator pad 42 is not extended, the tire guide 88 functions like a curb rail to guide the tire along the track or path 22. The tire guide also prevents the tires of a vehicle from rubbing against the applicator pad 42 when the pad is in a retracted position.

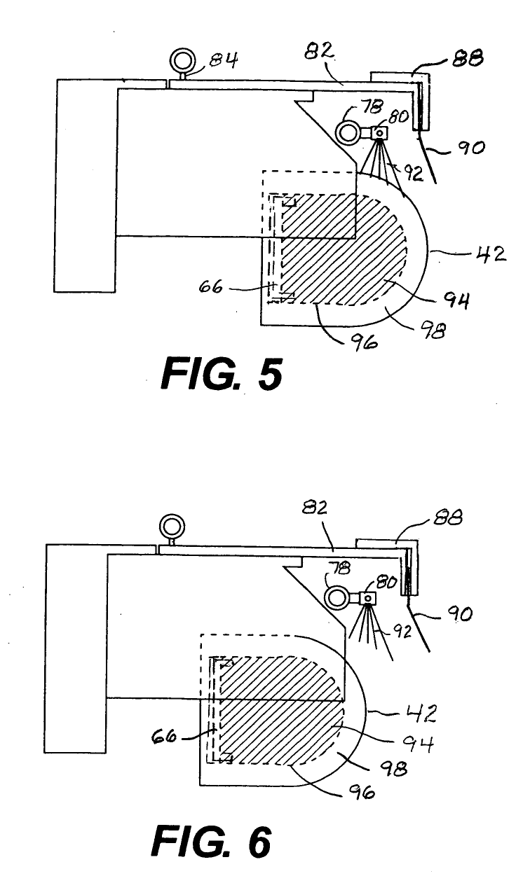

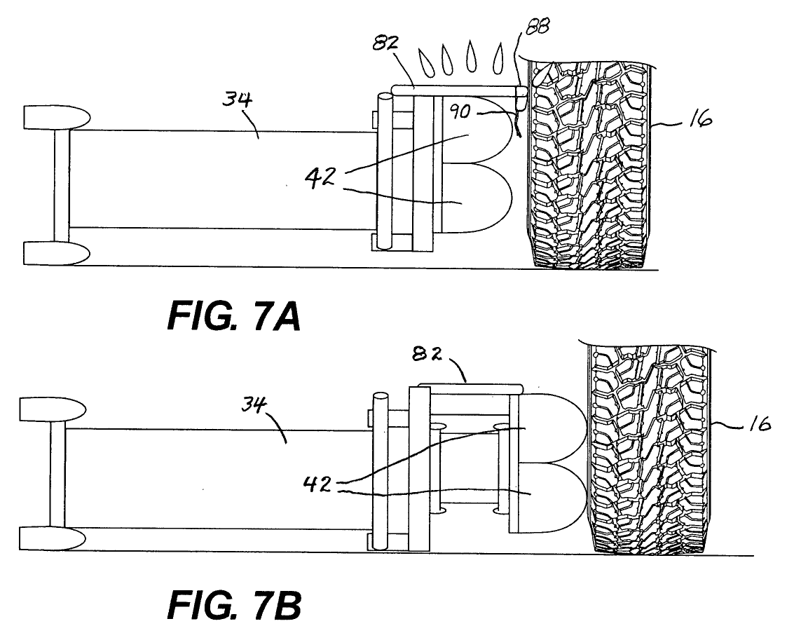

As shown in FIGS. 5 and 6, a protective shield 90 extends downwardly from the inner end of the removable cover 82 and the tire guide 88. The shield protects the applicator pad 42 from water or other materials when a vehicle is passing therethrough. Preferably the protective shield 90 is constructed of a flexible clear plastic material. The plastic shield is particularly designed to protect the applicator pad 42 when it is in a retracted position. The protective shield 90 also prevents water or other materials from diluting the chemical 92 being applied to the applicator pad 42 by the nozzles 80 attached to the manifold 78.

As shown in FIGS. 5 and 6, the applicator pad 42 is comprised of a center core 94 of foam rubber or other suitable similar material attached at its frame end to back frame member 66 which preferably is in the form of a tray to receive the end of the foam rubber core. The foam rubber core 94 in turn is covered by a layer of felt or ozite which fits like a glove over the foam rubber core. The ozite cover 96 can be secured to the foam rubber and the back frame member 66 by any suitable means such as a nylon zip tie or a velcro fastener. A thicker layer of a deep pile, fur-like material 98 is fastened over the ozite cover 96 and is attached to the rear frame member 96 by any suitable means such as being tied on the backside thereof or by means of velcro fasteners. The deep pile material is a tufted (randomly oriented) monofilament fibrous material manufactured by Borg Fabrics of New York, N.Y. The fabric is a deep pile material which has a fur-like appearance and preferably has a thickness or depth of from one-fourth of an inch to one inch. The fibers of the material are 85% polyester and 15% acrylic. The material is further described in my prior U.S. Pat. No. 5,077,859 which is incorporated herein by reference. The deep pile, fur-like material holds a suitable amount of fluid to apply an adequate coating to a vehicle tire.

By having the outer cover of the deep pile, fur-like material easily removable, the outer cover may be easily and quickly replaced, rather than having to replace the entire the applicator pad structure. When only foam rubber is used for the applicator pad, the pad must be replaced frequently since the foam rubber wears quickly. The outer cover of deep pile, fur-like material is far easier to replace than an entire foam rubber pad. Moreover, the removable top cover plate facilitates easy replacement of the outer cover.

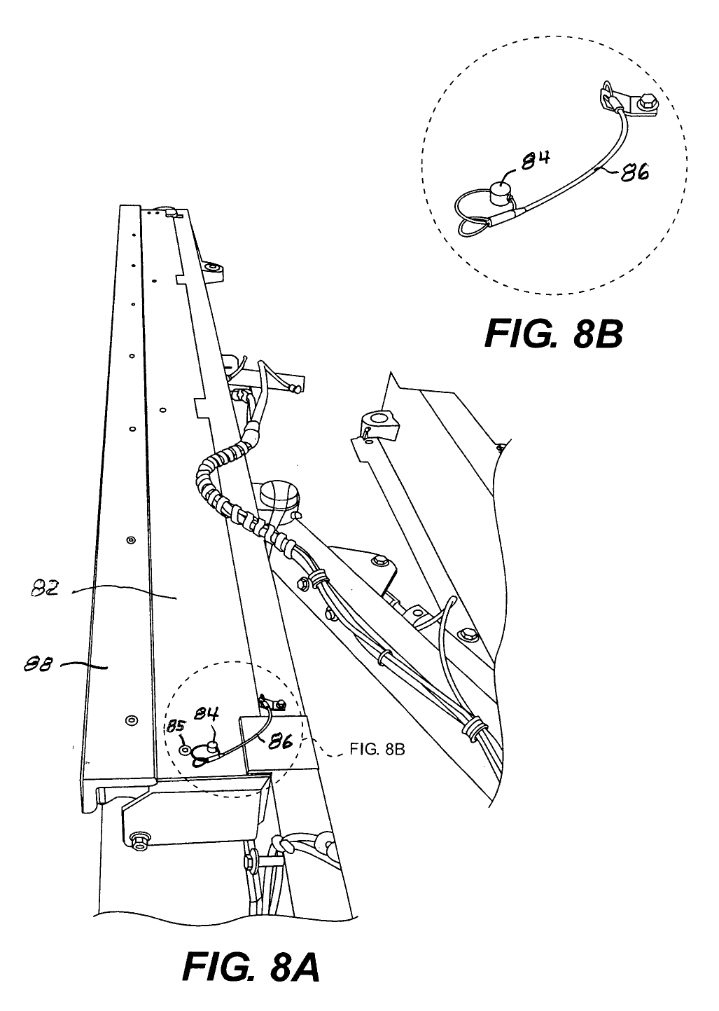

In a second embodiment of the invention as shown in FIGS. 7A and 7B, the applicator may include two applicator pads 42 stacked one above another. Each applicator pad may be of the same construction as that previously described having a foam rubber core, a cover or glove of ozite and an outer cover or layer of a deep pile, fur-like material. As shown in FIG. 7A, when the applicator pad 42 is in a retracted position, the edge of the tire guide 88 acts as a curb rail for the tire 16 whereas when the applicator pad 42 is extended, it directly contacts the outer side of a vehicle tire 16. The use of the double pad embodiment is advantageous in that the bottom pad picks up any chemical dropped from the first pad and applies it to the tire on the lower side thereof. This way very little if any of the chemical such as tire gloss is wasted.

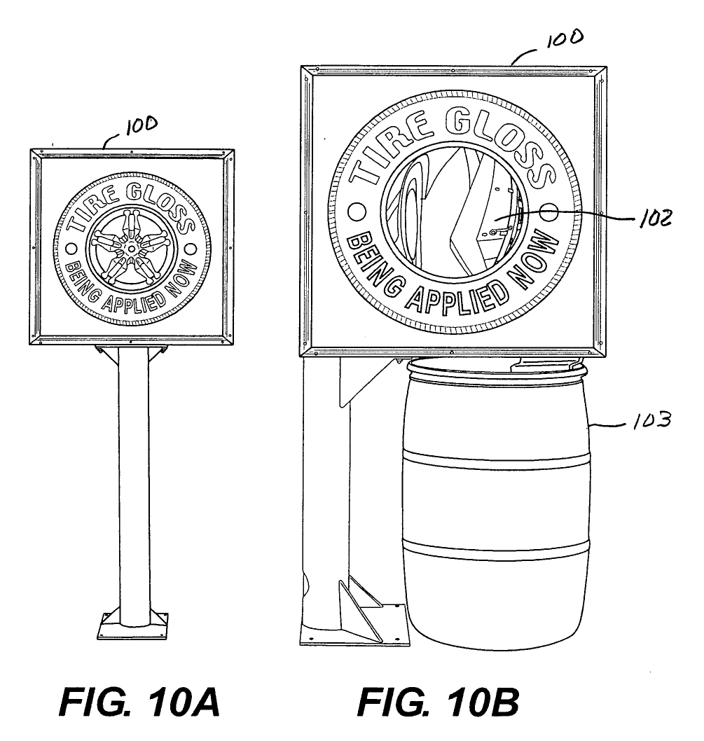

As shown in FIG. 1 and FIGS. 10A and 10B, the apparatus for applying a fluid to tires of a vehicle of the present invention further may include a sign 100 positioned on the right side of the apparatus. The sign lights up when a fluid is being applied to the tires of a vehicle so that a customer may readily see that the fluid is being applied. In the embodiment of the sign shown in FIG. 10A, only a sign is included. In the embodiment of the sign shown in FIG. 10B, however, the sign 100 further includes a convex mirror 102 on the side facing the apparatus so that an image is reflected in the mirror of the apparatus operating to apply a fluid such as a tire gloss to the sides of a tire. In FIG. 10B, a barrel 103 may be situated close to the sign for holding the chemical or other fluid which is being applied to the tire. The sign 100 also preferably includes a control panel in the inside thereof which is easily accessible.

In operation of the apparatus for applying a fluid to the tires of a vehicle moving along a predetermined path, when a customer indicates that an application of fluid such as a tire gloss is desired, a signal is entered into the control system. As the car moves through the vehicle washing facility, the car activates a switch by having a tire roll over a floor mounted switch positioned at a predetermined setting in front of the tire coating apparatus whereby the applicators move from a retracted position shown in FIG. 2 to an extended position shown in FIG. 1 with the applicator pads 42 and 62 being extended out into the path of the vehicle. The vehicle contacts right reflector 28, which is longer than left reflector 26 and causes the right applicator assembly 14 to adjust outwardly to accommodate the width of the vehicle. As the vehicle then moves through the apparatus, a coating fluid such as a tire gloss is then sprayed from the nozzles 80 onto the applicator pads whereby the fluid is applied to the sides of the tires on both sides of the vehicle. When the vehicle has passed through the apparatus, the tires of the vehicle may activate another switch which then retracts the applicators to the at-rest shown in FIG. 2.

The tire coating apparatus of the present invention has many advantages. The use of the first pair of swing arms to extend and retract the entire applicator assemblies and the use of a second means and extension arms for extending the applicator pads with respect to the applicators provides an efficient manner of ensuring that the applicator pads firmly contact the sides of the vehicle tires. Moreover, when the applicator are not extended but are retracted under the top cover plate of the applicator, the pads are protected by a flexible plastic shield so that water and other elements do not contact the applicator pads. The top cover plate of each applicator also is provided with a tire guide constructed of hard plastic material so that when the applicator are not extended, the tire guide acts a curb rail to further guide the vehicle through the path.

The top cover plate also is easily removable simply by removing the pins by pulling them out and sliding the button head screws on the bottom of the cover plate out of the slots on the applicator frame. When the top cover plate is removed, it therefore becomes very easy to remove and replace the outer cover of deep pile, fur-like material on the outside of the pad. By having only the outer cover easily removable, it is not necessary to replace an entire pad.

While the present invention has been described as been used to apply a fluid such as a tire gloss to vehicle tires, the apparatus may be used to apply other fluids such as a soap or other cleaner to a vehicle tire. The present invention also may be used to apply coatings or fluid to other moving surfaces.

Numerous other modifications and adaptations of the present invention will be apparent to those skilled in the art and thus, it is intended by the following claims, to cover all such modifications and adaptations which fall within the true spirit and scope of the invention.

What is claimed is:

1. An apparatus for applying a fluid to a vehicle tire comprising:
a base;
an applicator having a frame;
a pair of swing arms, each pivotally attached to said base at one end and pivotally attached to said applicator at an opposite end;
means for pivoting said swing arms to move said applicator outwardly and inwardly relative to said base;
an applicator pad mounted on said applicator;
means for extending and retracting said applicator pad relative to said applicator frame whereby said applicator pad engages the vehicle tire when extended; and
means for supplying the fluid to said applicator pad so that the fluid is applied to the vehicle tire when said applicator pad engages the vehicle tire.

2. The apparatus according to claim 1 wherein said means for extending and retracting said applicator pad comprises a pair of extension arms pivotally attached at one end to said applicator frame and pivotally attached at an opposite end to said applicator pad.

3. The apparatus according to claim 1 wherein said applicator has a removable top cover plate attached to said applicator frame.

4. The apparatus according to claim 3 which further comprises a tire guide attached to said cover plate.

5. The apparatus according to claim 4 wherein said tire guide is constructed of a plastic material.

6. The apparatus according to claim 3 which further comprises a protective shield extending downwardly from an inner edge of said cover plate.

7. The apparatus according to claim 1 wherein said applicator pad has a removable outer cover.

8. The apparatus according to claim 7 wherein said removable outer cover is comprised of a deep pile, fur-like material.

9. The apparatus according to claim 1 wherein said applicator pad comprises an inner body of foam rubber, a felt inner cover over said body and a removable outer cover constructed of a deep pile, fur-like material over said inner cover.

10. The apparatus according to claim 1 which further comprises an electric sign which is activated when the apparatus is operating.

11. The apparatus according to claim 10 wherein said sign further includes a concave mirror to reflect an image of the fluid being applied to the tire.

12. The apparatus according to claim 1 wherein said means for supplying the fluid to said applicator pad comprises a manifold extending along a length of said applicator and having a plurality of nozzles mounted thereto which spray the fluid onto said applicator pad.

13. The apparatus according to claim 1 wherein said means for pivoting said swing arms comprises a power cylinder connected between said base and one of said swing arms.

14. The apparatus according to claim 2 wherein said means for extending and retracting and retracting said applicator pad further comprises a power cylinder connected between said applicator and said applicator pad.

15. The apparatus according to claim 1 wherein said tire is on a vehicle moving along a predetermined path and said applicator constitutes a first applicator which is mounted on one side of said path whereby it applies the fluid to said tire on one side of said vehicle and said apparatus further comprises a second applicator mounted on an opposite side of said path from said first applicator whereby said second applicator applies the fluid to a tire on an opposite side of said vehicle.

16. The apparatus according to claim 3 wherein said cover plate is attached to said applicator frame by a plurality of removable pins.

17. The apparatus according to claim 1 wherein said applicator pad constitutes a first applicator pad and said apparatus further comprises a second applicator pad in stacked relationship with said first applicator pad.

18. An apparatus for applying a fluid to tires of a vehicle moving along a predetermined path, said apparatus comprising:
a base on each side of said path,
an applicator attached to each said base on each side of said path,
each said applicator comprising:
a pair of swing arms, each pivotally attached to said base at one end and pivotally attached to said applicator at an opposite end;
means for pivoting said swing arms to move said applicator outwardly and inwardly relative to said base;
an applicator pad mounted on said applicator;
a pair of extension arms pivotally attached at one end to said applicator frame and pivotally attached at an opposite end to said applicator pad;
means for extending and retracting said applicator pad relative to said applicator frame whereby said applicator pad engages a vehicle tire when extended; and
means for supplying the fluid to said applicator pad so that the fluid is applied to the vehicle tire when said applicator pad engages the vehicle tire.

19. The apparatus according to claim 18 wherein said applicator has a removable top cover plate attached to said applicator frame.

20. The apparatus according to claim 19 which further comprises a tire guide attached to said cover plate.

21. The apparatus according to claim 19 which further comprises a protective shield extending downwardly from an inner edge of said cover plate.

22. The apparatus according to claim 18 wherein said means for supplying the fluid to said applicator pad comprises a manifold extending along a length of said applicator and having a plurality of nozzles mounted thereto which spray the fluid onto said applicator pad.

23. The apparatus according to claim 18 wherein said means for pivoting said swing arms comprises a power cylinder connected between said base and one of said swing arms.

24. The apparatus according to claim 18 wherein said means for extending and retracting and retracting said applicator pad comprises a power cylinder connected between said applicator and said applicator pad.

25. The apparatus according to claim 19 wherein said cover plate is attached to said applicator frame by a plurality of removable pins.

26. The apparatus according to claim 18 wherein said applicator pad has a removable outer cover.

27. The apparatus according to claim 26 wherein said removable outer cover is comprised of a deep pile, fur-like material.

28. The apparatus according to claim 18 wherein said applicator pad comprises an inner body of foam rubber, a felt inner cover over said body and a removable outer cover constructed of a deep pile, fur-like material over said inner cover.

29. The apparatus according to claim 18 wherein said applicator pad constitutes a first applicator pad and said apparatus further comprises a second applicator pad in stacked relationship with said first applicator pad.
